(19) United States
(12) Patent Application Publication
(10) Pub. No.: US 2003/0146911 A1
(43) Pub. Date: Aug. 7, 2003

(54) Method for generating control signal, control-signal generation circuit, data-line driving circuit, element substrate, optoelectronic device, and electronic apparatus

(75) Inventor: Hayato Nakanishi, Toyama-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/347,704

(22) Filed: Jan. 22, 2003

(30) Foreign Application Priority Data
Jan. 22, 2002 (JP) 2002-013476
Jan. 21, 2003 (JP) 2003-012347

(51) Int. Cl. G09G 5/00

(52) U.S. Cl. 345/211

(57) ABSTRACT

The invention provides a method of generating a control signal to supply a sufficiently high voltage required to obtain a predetermined contrast ratio to a data line. A data-line driving circuit includes a shift register to control outputting of a sampling signal supplied via a sampling-signal line, a capacitive element having a first terminal connected to the sampling-signal line, a second terminal, and a capacitance provided therebetween, an image-signal line to transmit an image signal, and a switching element controlled by a control signal output from an output unit connected to the second terminal in response to the sampling signal supplied to the first terminal via the sampling-signal line. The switching element is turned on when the control signal is supplied, whereby the image signal transmitted through the image-signal line is transmitted to the data line via the switching element.

### BACKGROUND OF THE INVENTION

1. Field of Invention

The present invention relates to a method of generating a control signal, a control-signal generation circuit, a data-line driving circuit, an element substrate, an optoelectronic device, and an electronic apparatus.

2. Description of Related Art

FIG. 12 is a schematic of a circuit configuration of a liquid-crystal display that is an example of a related art optoelectronic device. An image display 60, a data-line driving circuit 20, and a scan-line driving circuit 10 are integrally formed on one substrate. The image display 60 includes a plurality of data lines Hᵢ (i=1 to n) and a plurality of scan lines Vⱼ (j=1 to m). Further, the image display 60 includes pixel transistors Tr provided at positions corresponding to the intersections of the data lines Hᵢ and the scan lines Vⱼ. Further, the image display 60 includes pixel electrodes (not shown) driven by the pixel transistors Tr and counter electrodes. Further, the image display 60 includes pixels formed by liquid crystal (LC) sandwiched between the pixel electrodes and the counter electrodes.

One of a source electrode and a drain electrode of each of the pixel transistors Tr is connected to the data line Hᵢ corresponding thereto. A gate electrode of each of the pixel transistors Tr is connected to the scan line Vⱼ corresponding thereto. The other of the source electrode and the drain electrode of each of the pixel transistors Tr is connected to the pixel electrode corresponding thereto.

When the liquid-crystal display is operated, the scan-line driving circuit 10 successively transfers a vertical start signal VST in synchronization with a vertical clock signal VCK and successively selects the scan line Vⱼ (j=1 to m) one by one. Consequently, the pixel transistors Tr corresponding to one row are selected during one horizontal scanning time.

The data-line driving circuit 20 includes a shift register 50 and a sampling circuit 70. The shift register 50 successively transfers a horizontal start signal HST in synchronization with a predetermined horizontal clock signal HCK and outputs a sampling signal hᵢ (i=1 to n) to a sampling gate φHᵢ (i=1 to n) of the sampling circuit 70.

The sampling signal hᵢ (i=1 to n) input to the sampling circuit 70 controls an analog switch ASWᵢ (i=1 to n) provided at one end of the data line Hᵢ (i=1 to n). Consequently, an image signal applied to a signal line 30 is selected and transmitted to the data line Hᵢ (i=1 to n). Further, the image signal is written in the pixel electrode by the pixel transistor Tr.

FIG. 13(a) is an exemplary timing chart showing the change of potential Vg of the gate electrode of the pixel transistor Tr, potential Vp of the pixel electrode, and potential Vid of the image signal supplied to the data line Hᵢ when the above-described liquid-crystal display is driven by a so-called 1H inversion driving method.

In FIG. 13(a), Vc indicates the center of the potential Vid of the image signal. Vcom indicates the potential of the counter electrode. T1 indicates a selection time where the gate electrode of the transistor Tr is selected, and T2 indicates a non-selection time. The sum of the selection time T1 where the gate electrode of the pixel transistor Tr is selected and the non-selection time T2 (one field) corresponds to one vertical scanning time.

FIG. 13(b) is an exemplary timing chart showing the time-series change of a sampling pulse Vgs of the analog switch ASWᵢ, potential Vdl of the data line, and the potential Vid of the image signal.

In FIG. 13(b), T3 indicates a time to select the analog switch ASWᵢ in the sampling circuit 70, and T4 indicates a non-selection time. The sum of the time T3 where the analog switch ASWᵢ is selected and the non-selection time T4 corresponds to one horizontal scanning time. In the time T3 where the analog switch ASWᵢ is selected, the potential of the data line agrees with the potential Vid of the image signal. In the selection time T1, the pixel transistor Tr is selected, and the potential Vp of the selected pixel electrode agrees with the potential of the data line Hᵢ.

### SUMMARY OF THE INVENTION

In order to obtain a required sufficient contrast ratio in the case of the above-described liquid-crystal display, a sufficient potential Vid must be supplied to the data line Hᵢ during the selection time T3 for the analog switch ASWᵢ. Therefore, it is necessary to provide a sufficient time to write the potential Vid into the data line Hᵢ.

However, in the related art, as the resolution of pixels has become higher, there has been a growing demand for a faster sampling rate of the analog switch ASWᵢ. Therefore, providing a sufficient time to write the potential Vid into the data line Hᵢ is difficult. Further, as the resolution of pixels has become higher, the number of stages of the shift register has increased. As for the shift register, there has been a growing demand in the related art for a faster operation. In the case where the shift register is operated at high speed and at a high voltage to attain a contrast rate, a horizontal resolution and the contrast rate may be decreased because of a decreased ON current and an increased OFF current caused by self-heating. Further, a ghost image may be formed.

In order to ensure the reliability of the driving transistor Tr, the power voltage supplied to the data-line driving circuit 20 can be decreased (V_{dd}→V_{ddl}) as shown in the timing chart of FIG. 14. However, the decreased power voltage can cause an increase in the time to write the potential Vid into the data line Hᵢ (a time constant). Consequently, a sufficient number of image signals V_{id} cannot be supplied to the data line in the writing time. Therefore, it becomes difficult to attain the contrast rate.

Accordingly, the present invention provides a method of generating a control signal, a control-signal generation circuit, a data-line driving circuit, an element substrate, an optoelectronic device, and an electronic apparatus to supply a sufficiently high voltage required to attain a predetermined contrast rate.

In order to address or achieve the above, a first exemplary method for generating a control signal is provided. According to this method, it becomes possible to generate a control signal to control transmission of a scan signal supplied to a pixel via a scan line or a data signal supplied to another pixel via a data line based on a sampling signal supplied via a sampling-signal line. The method includes a first step. In the first step, a floating time is provided to set the potential of a second terminal of a capacitive element having a first terminal, the second terminal, and a capacitance provided therebetween to a first potential, and to make the second terminal float. Further, in the first step, the potential of the first terminal is set to a second potential by supplying the sampling signal to the first terminal within the floating time, whereby the potential of the second terminal is set to a third potential generated by the first and second potentials. Further, the method includes generating the control signal based on the third potential.

According to a second exemplary method of generating a control signal of the present invention, the control signal is output by supplying the potential of the second terminal to a buffer circuit as an input signal.

According to a third exemplary method of generating a control signal, binary voltage values are output as the control signal in effect.

According to a fourth exemplary method of generating a control signal, the voltage value of the control signal that is output by supplying the first potential to the buffer circuit as an input signal of the buffer circuit is different from the voltage value of the control signal that is output by supplying the third potential to the buffer circuit as another input signal of the buffer circuit.

A fifth exemplary method of generating a control signal, further includes a second step before the first step. In the second step, the potential of the second terminal is set to the first potential by connecting the second terminal to a first power line via a first switching element.

A sixth exemplary method of generating a control signal, further includes a third step after the first step. In the third step, the potential of the second terminal is set to the first potential by connecting the second terminal to the first power line via the first switching element.

A seventh exemplary method of generating a control signal, further includes a fourth step after the first step. In the fourth step, the potential of the second terminal is set to a fourth potential by connecting the second terminal to a second power line via a second switching element.

An eighth exemplary method of generating a control signal, further includes a second step after the fourth step.

According to a ninth exemplary method of generating a control signal, a shift register controls output timing of the sampling signal.

According to a tenth exemplary method of generating a control signal, a sampling signal from another sampling-signal line adjacent to the sampling-signal line controls the first switching element.

According to an eleventh exemplary method of generating a control signal, a sampling signal from another sampling-signal line adjacent to the sampling-signal line controls the second switching element.

According to a twelfth exemplary method of generating a control signal, the sampling signal, which controls the first switching element, and the other sampling signal, which controls the second switching element, are supplied via sampling-signal lines different from each other.

A first exemplary control-signal generation circuit of the present invention is provided to output a control signal to control transmission of a scan signal supplied to a pixel via a scan line or a data signal supplied to another pixel via a data line based on a sampling signal supplied via a sampling-signal line. The control-signal generation includes a capacitive element having a first terminal connected to the sampling-signal line, a second terminal, and a capacitance provided therebetween. The control-signal generation further includes a first switching element connected to the second terminal. A voltage signal is output from an output terminal connected to the second terminal in response to the sampling signal supplied to the first terminal via the sampling-signal line, and the voltage signal is used as the control signal, or is processed and used as the control signal.

In a second exemplary control-signal generation circuit, the first switching element, which is connected to the second terminal, controls electrical connection between the first power line and the second terminal. The first switching element may be preferably controlled by a sampling signal supplied via a sampling signal line that is adjacent to the sampling signal line. If the first switching element is a transistor, a control terminal of the transistor is connected to the adjacent sampling signal line.

A third exemplary control-signal generation circuit, includes a second switching element connected to the second terminal to control electrical connection between the second terminal and the second power line. Each of the first switching elements and the second switching elements may be preferably controlled by a sampling signal supplied via a sampling signal line adjacent to the sampling signal line. For example, the first switching element may be preferably set at an on-state prior to supplying the sampling signal to the sampling signal line. The second switching element may be preferably set at an on-state after supplying the sampling signal to the sampling signal line, and with this structure the switch control which controls transmission of the signal to the data line or scan line can be effectively performed in a limited time.

In a fourth exemplary control-signal generation circuit, the first switching element sets the potential of the second terminal to a predetermined potential by electrically connecting the first power line and the second terminal. Further, in a period where the sampling signal is supplied to the first terminal, the first power line and the second terminal are electrically disconnected. That is to say, in the period where the sampling signal is supplied, the second terminal may preferably be floated.

In a fifth exemplary control-signal generation circuit, the first switching element and the second switching element are connected to a sampling-signal line connected to a capacitive element is different from the capacitive element, which has the second terminal to which the first switching element and the second switching element are connected. Particularly, the first switching element and the second switching element may preferably be controlled by sampling signals supplied via sampling-signal lines that are different from said sampling-signal line and are adjacent to said sampling-signal line.

In a sixth exemplary control-signal generation circuit, the second terminal of the capacitive element is connected to a buffer circuit. In the sixth control-signal generation circuit, the buffer circuit may preferably include an inverter circuit connected to the second terminal.

The center potential of the inverter circuit may preferably be set to a point midway between the potential of the second terminal in the period where the sampling signal is supplied and the potential of the second terminal in the period where the sampling signal is not supplied. Consequently, the potential of a control signal that is output can be binary-driven between the period where the sampling signal is supplied and the period where the sampling signal is not supplied.

In a seventh exemplary control-signal generation circuit, the potential of the first power line is set so as to be different from the potential of the second power line. For example, the potential of the first power line may be set to a setting potential before the sampling signal is supplied and the potential of the second power line may be set to a resetting potential after the sampling signal is supplied. The first switching element may be turned on before the sampling signal is supplied and the second switching element may be turned on after the second switching element is supplied, corresponding to the above-described settings of the potentials.

A first exemplary data-line driving circuit of the present invention includes a control-signal generation circuit provided for each of the sampling-signal lines, a shift register to control output timing of the sampling signal, and at least one switching element controlled by an output from the control-signal generation circuit.

A second exemplary data-line driving circuit of the present invention is provided to supply an image signal to a pixel circuit provided at a position corresponding to the intersection of a data line and a scan line via the data line. The second data-line driving circuit includes a shift register to control outputting of a sampling signal supplied via a sampling-signal line and a capacitive element having a first terminal connected to the sampling-signal line, a second terminal, and a capacitance provided therebetween. Further, the second exemplary data-line driving circuit includes an image-signal line to transmit an image signal and a switching element controlled by a control signal output from an output unit connected to the second terminal in response to the sampling signal supplied to the first terminal via the sampling-signal line. The switching element is turned on when the control signal is supplied, whereby the image signal transmitted through the image-signal line is transmitted to the data line via the switching element.

In a third exemplary data-line driving circuit, the control signal is only output in a period where the sampling signal is supplied to the first terminal.

In a fourth exemplary data-line driving circuit, the output unit includes a buffer circuit connected to the second terminal. An output from the buffer circuit in the case where the potential of the second terminal in the period where the sampling signal is supplied to the first terminal is input to the buffer circuit, and another output from the buffer circuit in the case where the potential of the second terminal in a period where the sampling signal is not supplied to the first terminal is input to the buffer circuit are different from each other.

Thus, by setting the condition of the buffer circuit, it becomes possible to control the switching element to transmit the image signal to the data line so that the switching element can be turned on or off.

In a fifth exemplary data-line driving circuit, the buffer circuit includes an inverter circuit connected to the second terminal. The center potential of the inverter circuit is set to a point midway between the potential of the second terminal in the period where the sampling signal is supplied to the first terminal and the potential of the second terminal in the period where the sampling signal is not supplied to the first terminal.

An element substrate of the present invention includes a substrate, a scan line formed on the substrate, a pixel circuit formed on the substrate, a scan-line driving circuit formed on the substrate to supply a scan signal to the pixel circuit via the scan line, the above-described data-line driving circuit formed on the substrate, and a data line formed on the substrate to supply an image signal output from the data-line driving circuit to the pixel circuit.

Further, an optoelectronic device of the present invention includes an optoelectronic element, a pixel circuit to drive the optoelectronic element, a scan line, a scan-line driving circuit to supply a scan signal to the pixel circuit via the scan line, and the above-described data-line driving circuit, and a data line to supply an image signal output from the data-line driving circuit to the pixel circuit.

An electronic apparatus of the-present invention includes the above-described optoelectronic device.

An eighth control signal generation circuit of the present invention is provided to output a control signal to control transmission of a scan signal supplied to a pixel via a scan line or a data signal supplied to the pixel via the data line, including: a signal conversion unit having a first terminal and a second terminal; a first sampling signal line connected to the first terminal, which supplies a first sampling signal; and a second sampling signal line connected to the second terminal, which supplies a second sampling signal; the control signal being generated based on a first potential at the first terminal and a second potential at the second terminal, the first potential at the first terminal being controlled by the first sampling signal; and the second potential at the second terminal being controlled by the second sampling signal.

According to this type of structure, it is possible to reduce overlap of control signals to control the switch of the sampling, even if the timing of two sampling signals overlaps.

The signal conversion unit is a circuit, e.g., including a capacitive element, a transistor or the like.

### BRIEF DESCRIPTION OF THE DRAWINGS

FIG. 1 is a schematic of a data-line driving circuit according to an exemplary embodiment of the present invention;

FIG. 2(a) is a schematic of an equivalent circuit diagram of part of a data-line driving circuit according to another exemplary embodiment of the present invention, FIG. 2(b) is a schematic that shows the potential of a terminal P_{i+1,2} shown in FIG. 2(a) changing with the passage of time, and FIG. 2(c) is a schematic that shows the potential of the terminal P_{i+1,3} shown in FIG. 2(a) changing with the passage of time;

FIG. 3 is a timing chart illustrating a method of driving the data-line driving circuit of the present invention;

FIG. 4 is a schematic of a data-line driving circuit according to another embodiment of the present invention;

FIG. 5(a) is a schematic circuit diagram illustrating an exemplary control-signal generation circuit of the present invention, and FIGS. 5(b) and 5(c) are schematic circuit diagrams, each illustrating a partial block of the circuit shown in FIG. 5(a);

FIG. 6 is a timing chart illustrating a method of driving a control-signal generation circuit according to another exemplary embodiment of the present invention;

FIG. 7 is a timing chart illustrating another method of driving a control-signal generation circuit according to another exemplary embodiment of the present invention;

FIG. 8 is a schematic of an optoelectronic device using the data-line driving circuit of the present invention;

FIG. 9 is a schematic of a liquid-crystal projector that is an example of an electronic apparatus using the optoelectronic device of the present invention;

FIG. 10 is a schematic that shows a personal computer that is an example of an electronic apparatus using the optoelectronic device of the present invention;

FIG. 11 is a schematic that shows a liquid-crystal display that is a part of the electronic apparatus using the optoelectronic device of the present invention;

FIG. 12 is a schematic of the circuit configuration of a related art liquid-crystal display;

FIGS. 13(a) and 13(b) are timing charts illustrating a method of driving the related art liquid-crystal display;

FIG. 14 is another timing chart illustrating another method of driving the related art liquid-crystal display.

### DETAILED DESCRIPTION OF PREFERRED EMBODIMENTS

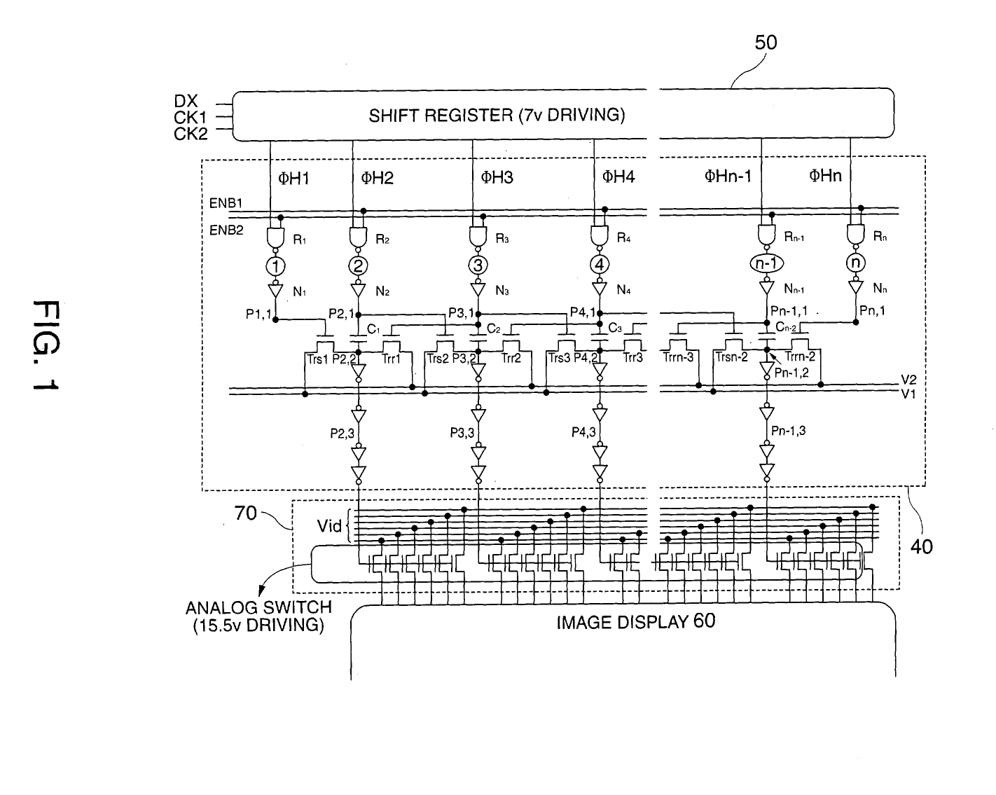

FIG. 1 is a schematic of a data-line driving circuit of an optoelectronic device. In the optoelectronic device, a control-signal generation circuit according to an embodiment of the present invention is used. The configurations of other parts of the optoelectronic device, that is, a scan-line driving circuit 10, an image display 60, and so forth, are the same as in the above-mentioned case. Therefore, the descriptions thereof are omitted.

The data-line driving circuit includes a boosting circuit 40 between a shift register 50 and a sampling circuit 70. The shift register 50 successively outputs a sampling signal hᵢ (i=1 to n) to a sampling-signal line φHᵢ (i=1 to n) at a predetermined time interval in one horizontal scanning time based on a direction-control signal DX and clock signals CK1 and CK2 that are input.

The sampling signal hᵢ (i=1 to n) is input to one of input terminals of a NAND element Rᵢ (i=1 to n) provided corresponding to the sampling-signal line φHᵢ (i=1 to n). An enable signal ENB2 is input to the other input terminal of the NAND element Rᵢ (i=1, 3, 5 . . . ) and an enable signal ENB1 is input to the other input terminal of the NAND element Rᵢ (i=2, 4, 6 . . . ).

An output signal from the NAND element Rᵢ (i=1 to n) is wave-shaped by a NOT element Nᵢ (i=1 to n) provided corresponding to the NAND element Rᵢ. Then, the output signal is output to a terminal P_{i,1} (i=1 to n). Here, the terminal P_{i,1} (i=1 to n−2) is connected to the gate electrode of a set transistor Trsᵢ (i=1 to n−2). The terminal P_{i,1} (i=3 to n) is connected to the gate electrode of a reset transistor Trrᵢ (i=1 to n−2). Further, the terminal P_{i,1} (i=2 to n−1) is connected to one end of a capacitive element Cᵢ (i=1 to n−2).

One of a drain electrode and a source electrode of the set transistor Trsᵢ (i=1 to n−2) is connected to a power line to supply a voltage V1. The other is connected to P_{i+1,2} (i=2 to n−1).

Similarly, one of the drain electrode and the source electrode of the reset transistor Trrᵢ (i=1 to n−2) is connected to a power line to supply a voltage V2. The other is connected to P_{i+1,2} (i=2 to n−1).

A signal transmitted to the terminal P_{i,2} (i=2 to n−1) passes through a wave-shaping buffer circuit. Then, the signal is transmitted to the terminal P_{i,3} (i=2 to n−1). The transmitted signal passes through another buffer circuit and is input to the gate of a transistor forming an analog switch of the sampling circuit as a control signal. The transistor is turned on by the control signal, whereby an image signal is transmitted from an image-signal line Vid to a data line provided in the image display 60.

Accordingly, a capacitive element, which has a first terminal, second terminal, and a capacitance therebetween, is arranged in correspondence with a signal line to each of the sampling signal lines, while the first terminal of the element is connected to a first sampling signal line of the sampling signal lines and the second terminal is connected to a transistor controlled by a second sampling line next to the first sampling line.

Considering the timing when a sampling signal is supplied, a control signal by which the sampling circuit is set to be on-state is generated by a first sampling signal supplied to a sampling signal line arranged in correspondence with a signal line to which the control signal is supplied and a second sampling signal which is supplied immediately before the first sampling signal is supplied.

The first sampling signal is also used when a next-supplied control signal by which the switch is set to be on-state is generated.

A second sampling signal that is supplied after the first sampling signal is used as a signal that changes the switch of the sampling circuit from “on” to “off”.

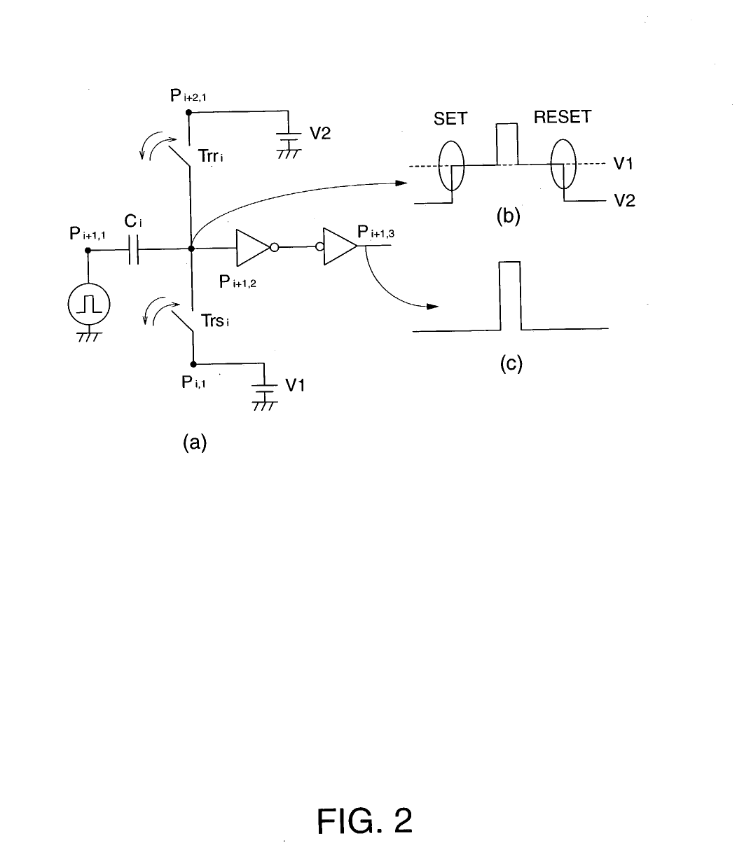

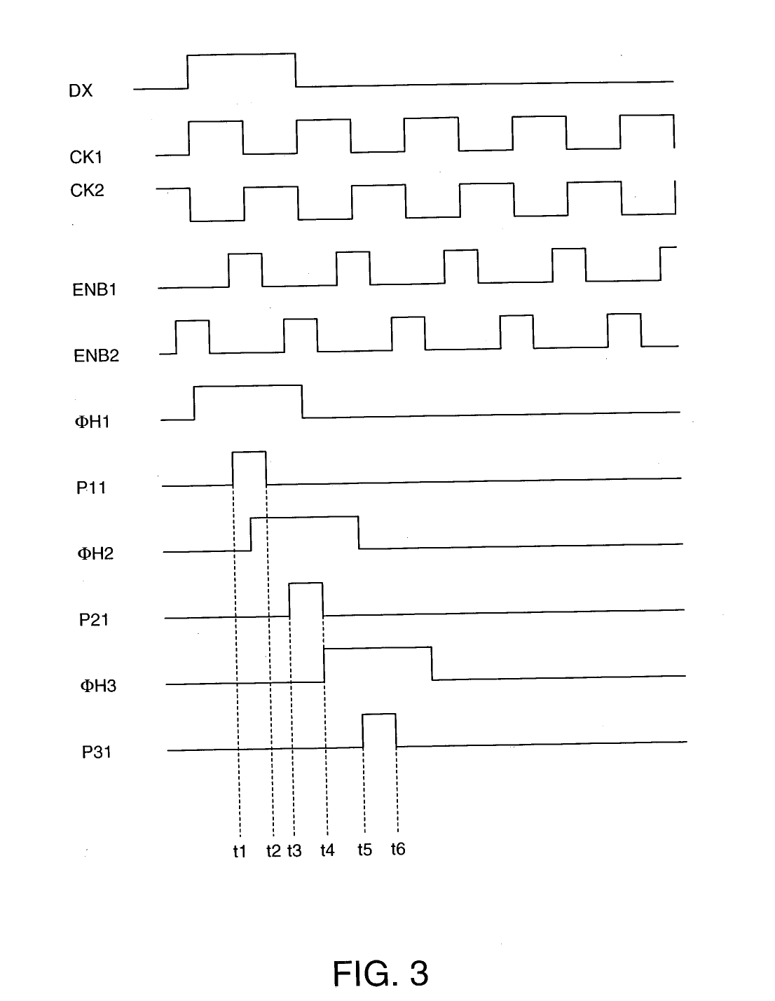

Operations performed when an n transistor is used as the transistor, which forms the analog switch, are described with reference to FIGS. 2(a), 2(b), 2(c), and 3. FIG. 2(a) is an equivalent circuit diagram of a part of boosting circuit 40, which is included in the data-line driving circuit 20, mainly showing the capacitive elements Cᵢ, the set transistors Trsᵢ, and the reset transistors Trrᵢ.

FIG. 3 is a timing chart illustrating a method for driving the above-described data-line driving circuit. Here, the operation of the boosting circuit 40 is described with reference to FIGS. 2(a), 2(b), 2(c), and 3.

First, a signal is transmitted to the terminal P_{i,1} in a time t1 to t2, whereby the set transistor Trsᵢ is turned on. Consequently, the potential of P_{i+1,2} becomes V1. In a time t3 to t4, the set transistor Trsᵢ is turned off, and the P_{i+1,2}-side terminal of the capacitive element (the first terminal) is detached from the power potential. (Such a state is hereinafter referred to as “a floating state”). Then, the sampling signal is transmitted to the terminal P_{i+1,1} (the first terminal of the capacitive element). At that time, the potential of P_{i+1,2} becomes V=V1+(Cᵢ/(Cᵢ+Cₚₐᵣ))×(the potential of P_{i+1,1} in a sampling time-the potential of P_{i+1,1} in a non-sampling time) due to capacitive coupling. Cₚₐᵣ indicates a parasitic capacitance other than the capacitive element.

First, a signal is transmitted to the terminal P_{i+2,1} in a time t5 to t6, whereby the reset transistor Trrᵢ is turned on. Consequently, potential V2 is applied to the capacitive element Cᵢ. Therefore, if the potential V2 is set so that a signal that can turn off the analog switch, which forms the sampling circuit 70, can be output, the analog switch can be turned off during the non-sampling time.

Consequently, the potential of the terminal P_{i+1,2} changes with the passage of time as illustrated by a waveform shown in FIG. 2(b). The buffer circuit including two stages of NOT elements provided between the terminal P_{i+1,2} and the terminal P_{i+1,3} is a circuit to remove both shoulder parts of the waveform shown in FIG. 2(b). The buffer circuit outputs a signal only when the potential of the terminal P_{i+1,2} is higher than a threshold voltage Vₜₕ of the buffer circuit.

As the threshold voltage Vₜₕ is set to a higher level than that of the voltage V1, the potential that passed through the buffer circuit, that is, the potential of the terminal P_{i+1,3} changes with the passage of time as shown in FIG. 2(c). As in the above-described manner, the sampling signal hi that is output from the shift register 50 is boosted.

Of course, if the threshold voltage Vₜₕ is set to a higher level than that of the voltage V1, the potentials of the voltages V1 and V2 may be identical. In such a case, only one power line may be provided instead of providing the two power lines to supply the voltages V1 and V2.

The boosted sampling signal is input to the buffer circuit (a positive/negative determination circuit mainly including an inverter) formed by the plurality of NOT elements (the two NOT elements in this circuit). Further, the boosted sampling signal transmitted through another buffer circuit formed by a plurality of NOT elements (two NOT elements in this circuit) to the sampling circuit 70 as an output signal Pᵢ (1 to n−1) from the boosting circuit 40. The plurality of buffer circuits is provided to obtain a signal large enough to drive the scan line and the data line.

Generally, if a voltage is supplied to the buffer circuit (the positive/negative determination circuit) in the floating state, it is not possible to supply sufficient quantities of electrical charges to the buffer circuit. Therefore, usually, the size of a TFT forming the buffer circuit should be reduced as much as possible, even though the reliability of the buffer circuit may be decreased. However, in the circuit according to the present invention, the current passing therethrough can be completely interrupted even though a moderate voltage is not applied to the input side of the buffer circuit (the positive/negative determination circuit) during the non-sampling time. In such a case, the reliability of the buffer circuit can be secured and the power consumption is reduced.

In the above-described case, the control-signal generation circuit according to the present invention is used for the data-line driving circuit of the optoelectronic device. However, the control-signal generation circuit can be used for the scan-line driving circuit.

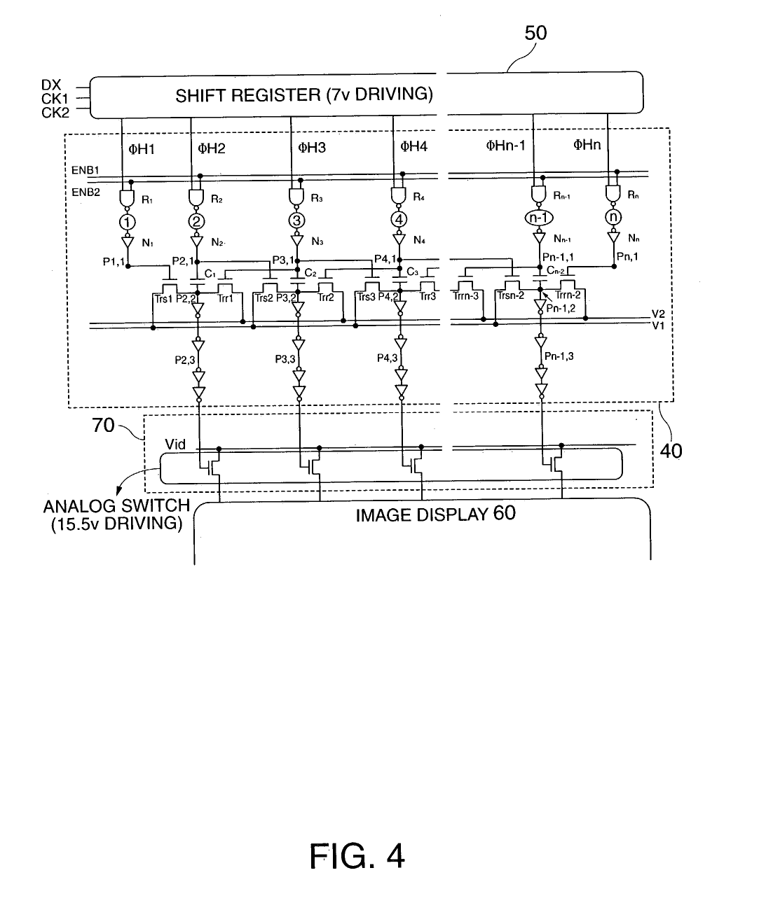

According to the configuration shown in FIG. 1, the one output signal pᵢ that is output from the boosting circuit 40 switches the potential Vid for the plurality of image signals. However, as shown in FIG. 4, the one output signal pᵢ may control the one analog switch.

The correspondence between the sampling-signal lines and the analog switches is not limited to the above-described case. The one sampling-signal line may control all of the analog switches.

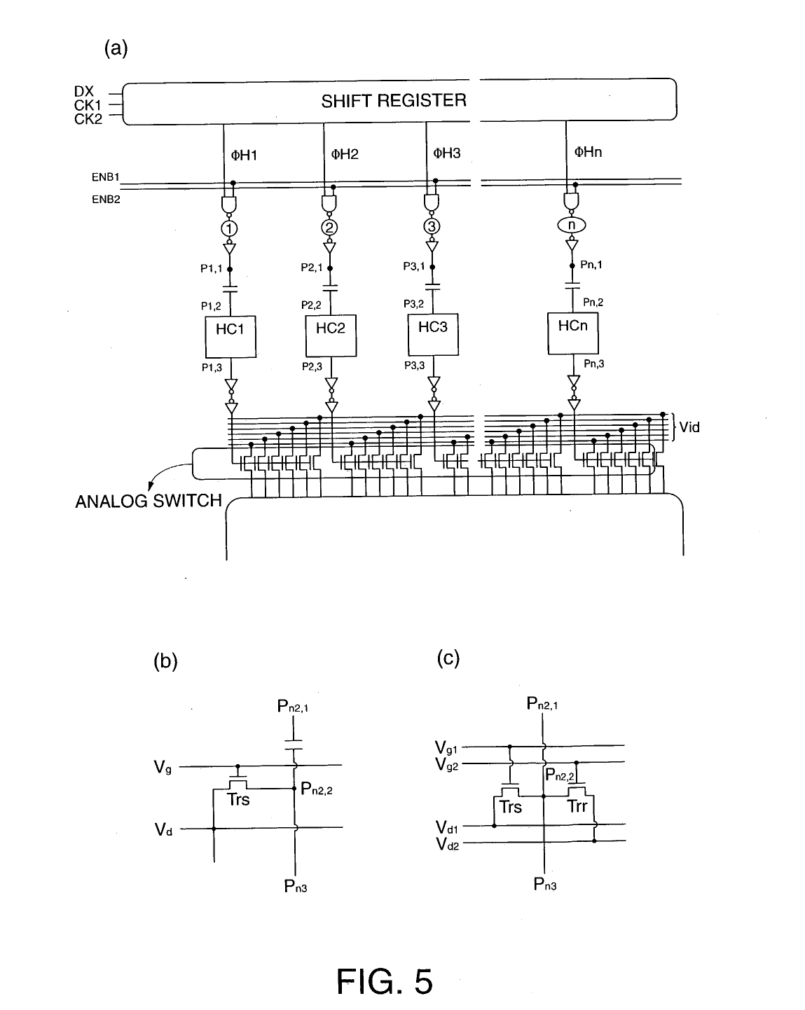

The above-described control-signal generation circuit boosts a sampling signal by using front/rear sampling signals, output from the shift register, of the sampling signal. However, the front/rear sampling signals do not have to be used. FIG. 5(a) shows a circuit used in the case where the front/rear sampling signals are not used.

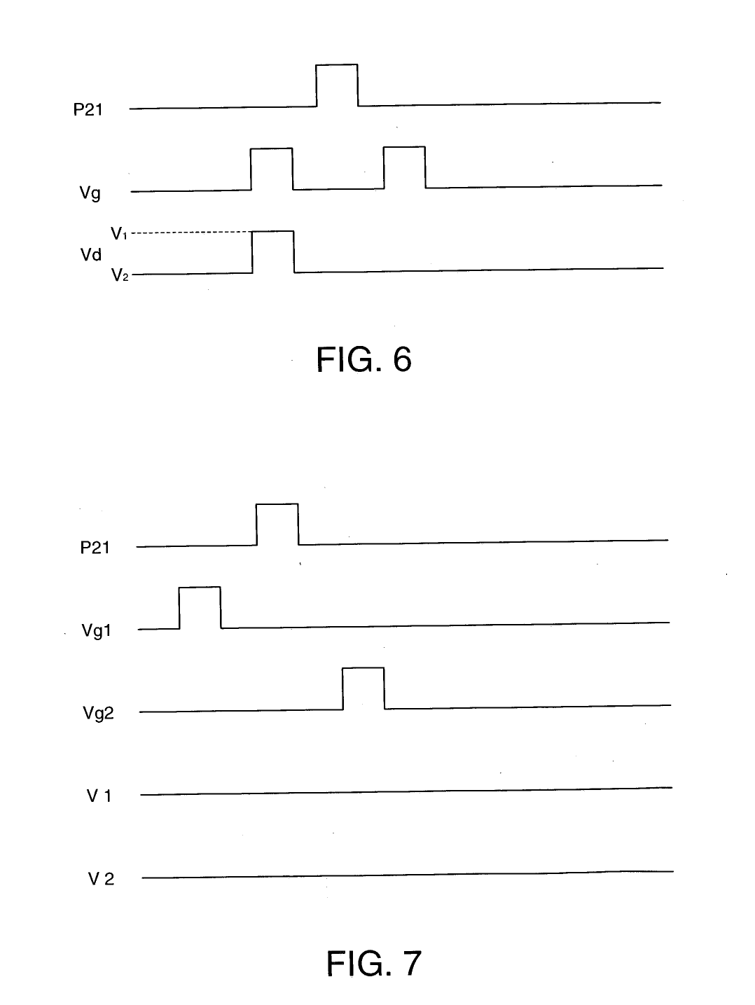

The circuit shown in FIG. 5(b) or the circuit shown in FIG. 5(c) can be used in the blocks HC1 to HCn of FIG. 5(a). In the case where the circuit shown in FIG. 5(b) is used, the sampling signal is boosted, for example, by V_{g1} and V_{g2} that are input as shown in a timing chart of FIG. 6. That is to say, the power voltage Vd is applied, as the voltage V1, to P_{n2,2} at one end of the capacitive element via the transistor Trs at least in a period where the potential Vg becomes a voltage that can turn the transistor Trs on. Consequently, the transistor Trs is turned off and the P_{n2,2} enters the floating state. Then, a voltage is applied from P_{n2,1} at the other end of the capacitive element, whereby the potential of P_{n2,2} is boosted. The power voltage Vd is changed into the voltage V2 and is applied from P_{n2,1}, whereby the potential of the P_{n2,2} is decreased to the voltage V2. If the threshold voltage of the buffer circuit connected to P_{n2,2} is set so as to be higher than the voltage V1 and lower than the voltage after capacitive coupling, it becomes possible to more reliably turn on an analog switch corresponding to a sampling-signal line to which a sampling signal is output from the shift register.

In the case shown in FIG. 6, the power voltage Vd may not be changed and may be fixed to the voltage V1.

As shown in FIG. 5(c), the gate electrode of a set transistor Trs and the gate electrode of a reset transistor Trr may be connected to control lines Vg1 and Vg2 that are different from each other. Further, one end of the set transistor Trs may be connected to a set power supply Vdl and one end of the reset transistor Trr may be connected to a reset power supply Vd2. In such a case, there is no need to change the potentials of the power supplies. Therefore, stable operation can be achieved.

(Electronic Apparatus)

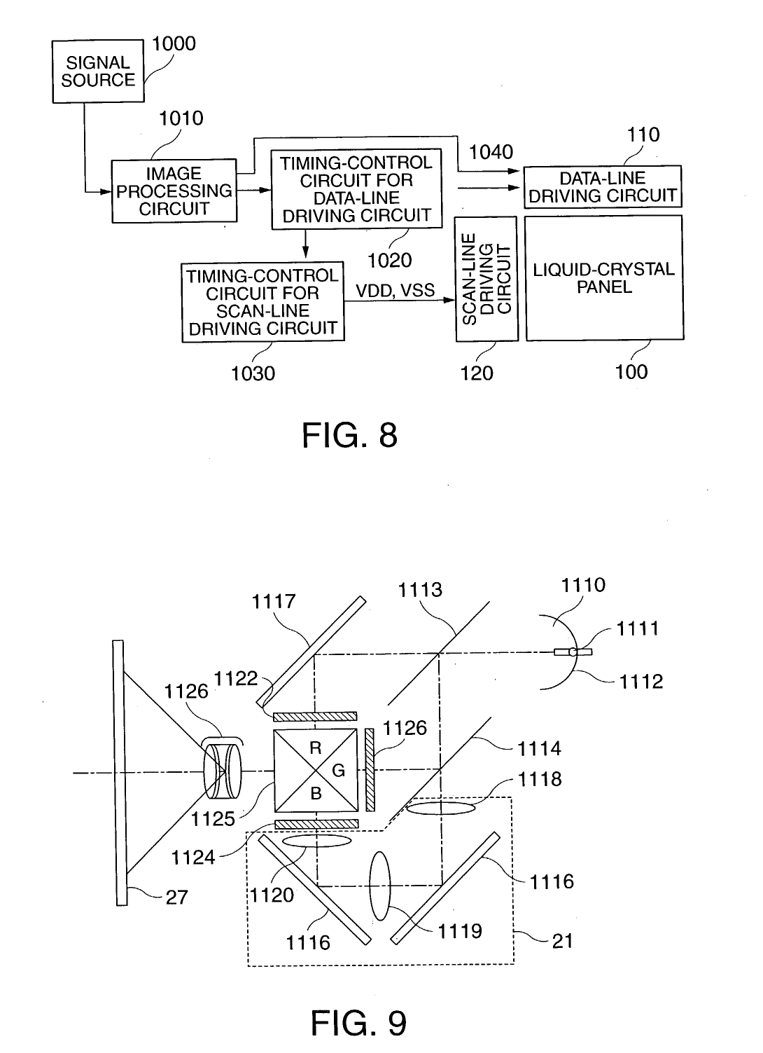

Next, an embodiment where the above-described data-line driving circuit is used is described. FIG. 8 is a schematic of an optoelectronic device using the data-line driving circuit of the present invention. The optoelectronic device includes a signal source 1000, an image-processing circuit 1010, a timing-control circuit 1020 for the data-line driving circuit, a timing-control circuit 1030 for a scan-line driving circuit, a data-line driving circuit 110, a scan-line driving circuit 120, and a liquid-crystal panel 100. The signal source 1000 includes memories, such as a ROM (a read only memory), a RAM (a random access memory), an optical-disk unit, and so forth. The signal source 1000 further includes a clock generation circuit or the like. The clock generation circuit is provided to synchronize a tuned circuit to tune and output a TV signal and all circuits that are used. The signal source 1000 outputs display information, such as image signals, in a predetermined format based on clock signals from the clock-generation circuit to the image-processing circuit 1010. The image-processing circuit 1010 includes related art processing circuits, such as an amplifier-polarity inverting circuit, a phase-developing circuit, a rotation circuit, a gamma-correction circuit, a clamp circuit, and so forth, for example. An analog-image signal output from the image-processing circuit 1010 is input to the data-line driving circuit 110. By using the display information that is input based on the clock signals from the clock-generation circuit, digital signals are successively generated in the timing-control circuit 1030 for the data-line driving circuit. The digital signals are output to the data-line driving circuit 110 with the clock signals. The data-line driving circuit 110 performs analog point-sequential driving. The timing-control circuit 1030 for the scan-line driving circuit outputs a timing signal in a scanning direction that is formed based on a clock-control signal from the timing-control circuit 1020 for the data-line driving circuit to the scan-line driving circuit 120. The liquid-crystal panel 100 is driven by the scan-line driving circuit 110 and the data-line driving circuit 120.

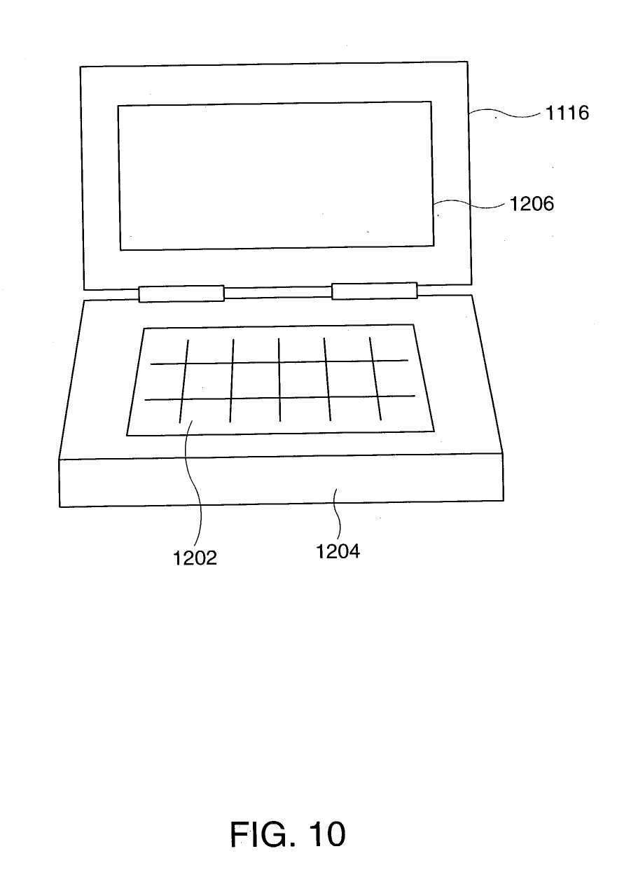

Various electronic apparatus can incorporate the above-described configuration. For example, a liquid-crystal projector shown in FIG. 9, a multimedia-capable personal computer (a PC) shown in FIG. 10, an engineering workstation (an EWS), a mobile phone, a word processor, a TV, a view-finder video tape recorder or a monitor-direct-view video tape recorder, an electronic pocketbook, an electronic desktop calculator, a car navigation apparatus, a POS terminal, and an apparatus having a touch-sensitive panel, can incorporate the structure discussed above.

The liquid-crystal projector 1100 shown in FIG. 9, which is an example of an electronic apparatus incorporating the above structure, is of a projection type. The liquid-crystal projector includes a light source 1110, dichroic mirrors 1113 and 1114, reflection mirrors 1115, 1116, and 1117, an incident lens 1118, a relay lens 1119, an outgoing lens 1120, liquid-crystal light bulbs 1122, 1123, and 1124, a cross dichroic prism 1125, and a projection lens 1126. The liquid-crystal light bulbs 1122, 1123, and 1124 are formed as three liquid-crystal modules. Each of the liquid-crystal modules includes the above-described liquid-crystal panel 100 having a driving circuit mounted on a TFT array substrate. The light source 1110 includes a lamp 1111, such as a metal halide lamp, and a reflector 1112 to reflect the light of the lamp 1111.

In the above-described liquid-crystal projector 1100, the dichroic mirror 1113, which reflects blue light and green light, allows red light of a white luminous flux from the light source 1110 to pass therethrough. After passing through the dichroic mirror 1113, the red light is reflected by the reflection mirror 1117 and is made incident on the red-light liquid-crystal light bulb 1122. Green light of the color light, which is reflected by the dichroic mirror 1113, is reflected by the dichroic mirror 1114 to reflect green light. Then, the green light is made incident on the green-light liquid-crystal light bulb 1123. Blue light passes through the second dichroic mirror 1114. In order to prevent an optical loss of the blue light due to a long optical path, there is provided a light-guiding device 21 including a relay lens system having the incident lens 1118, the relay lens 1119, and the outgoing lens 1120. The blue light is made incident on the blue-light liquid-crystal light bulb 1124 via the light-guiding device 21. The three color lights modulated by the light bulbs are made incident on the cross dichroic prism 1125. The cross dichroic prism 1125 includes four rectangular prisms that are bonded with one another. Multilayered dielectric films to reflect red light and multilayered dielectric films to reflect blue light are provided between the inner surfaces of the four rectangular prisms so that they have the form of a cross. These multilayered dielectric films generate three color lights, whereby light that can form a color image is generated. The generated light is projected on a screen 27 by a projection lens 1126 that is a projection optical system, and an enlarged image is displayed.

In FIG. 10, a laptop personal computer that is another example of an electronic apparatus incorporating the above structure includes a liquid-crystal display 1206 with a top cover case including the above-described liquid-crystal panel, and a body unit 1204 accommodating a CPU, a memory, a modem, and so forth, and a keyboard 1202 mounted therein.

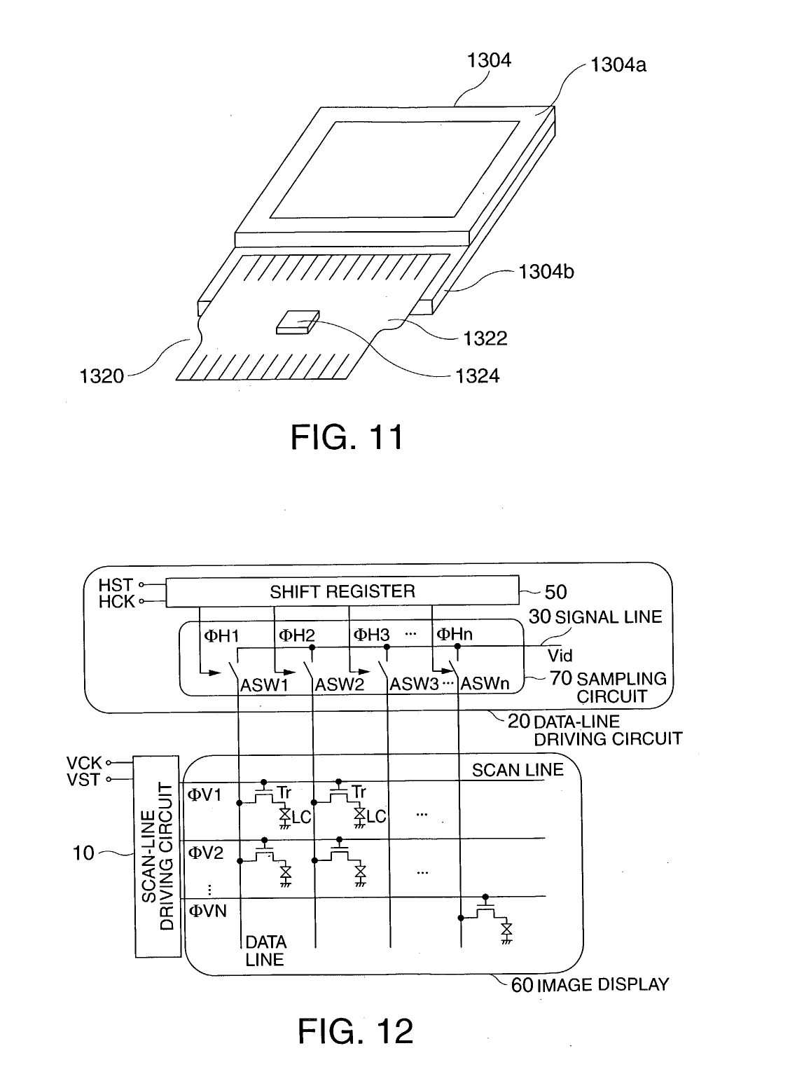

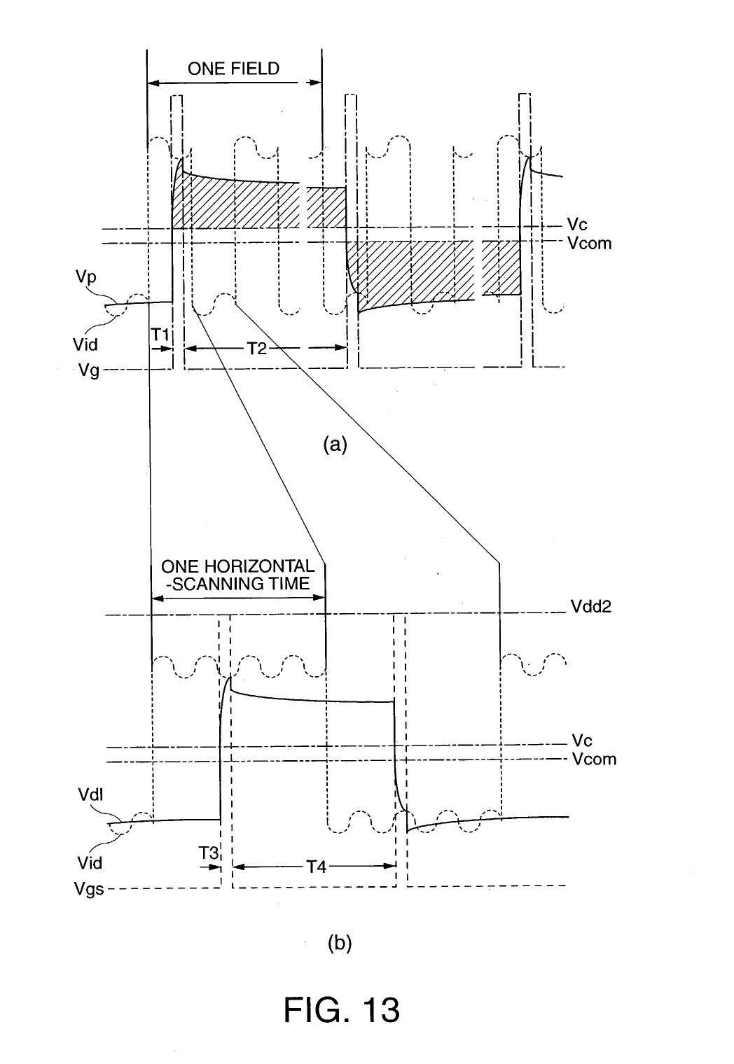

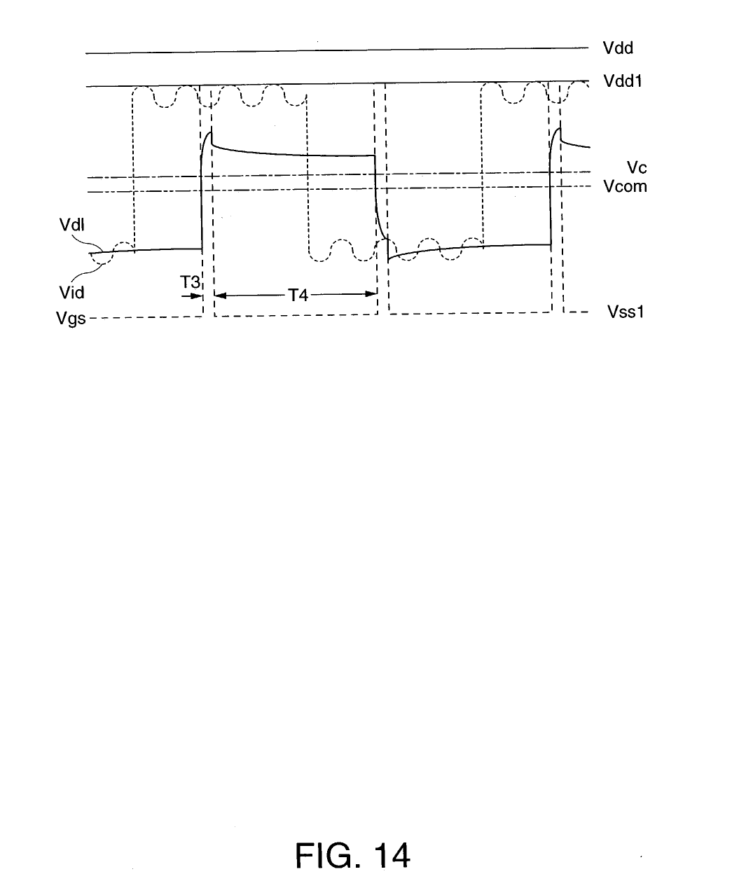

A liquid-crystal device shown in FIG. 11 has liquid crystal that is sealed in between two transparent substrates 1304a and 1304b, and a liquid-crystal-device substrate 1304 including the above-described driving circuit mounted on the TFT array substrate. A TCP (a tape-carrier package) 1320 having a chip 1324 mounted on a polyimide tape 1322 with a metal conductive film formed thereon is connected to one of the two transparent substrates 1304a and 1304b, which form the liquid-crystal-device substrate 1304. The liquid-crystal device may be manufactured, sold, and used as a liquid-crystal device acting as a part of the electronic apparatus.

Other than the above-described electronic apparatus, a liquid-crystal TV, a view-finder type or monitor-direct-view type video tape recorder, a car navigation apparatus, an electronic pocketbook, an electronic desktop calculator, a word processor, a work station, a mobile phone, a video phone, a POS terminal, and an apparatus having a touch-sensitive panel can be considered as examples of electronic apparatus incorporating the invention. However, the invention is intended to cover various other electronic apparatus.

The above-described electronic apparatus includes the optoelectronic device according to the present invention. Therefore, in the case where a sampling frequency is increased and the selection time of the analog switch is decreased as the resolution of an image becomes higher, the above-described electronic apparatus can decrease the number of phase development of an analog image signal by changing the power voltage supplied to the data-line driving circuit. Accordingly, if the number of phase development of the analog image signal is decreased, it becomes possible to write into the data line sufficiently, and the number of external periphery circuits required for the phase development is decreased. Therefore, the size and weight of the electronic apparatus can be reduced.

Further, by reducing an unnecessary gate-source voltage of the analog switch ASWᵢ, the reliability of the data-line driving circuit 20 can be increased. Because the operating speed of the data-line driving circuit 20 is the fastest of those of the other parts, the reliability thereof is most important. Therefore, the reliability of an active-matrix liquid-crystal display including periphery driving circuits can be increased by increasing the reliability of the data-line driving circuit 20, whereby the reliability of the electronic apparatus including the liquid-crystal display can be increased.

[Advantages]

According to the present invention, a sufficiently high voltage can be supplied to the data line or the like.

What is claimed is:

1. A method of generating a control signal to control transmission of a scan signal supplied to at least one of a pixel via a scan line and a data signal supplied to another pixel via a data line based on a sampling signal supplied via a sampling-signal line, the method comprising:
providing floating time to set the potential of a second terminal of a capacitive element having a first terminal, the second terminal, and a capacitance provided therebetween to a first potential, and to make the second terminal float, and to set the potential of the first terminal to a second potential by supplying the sampling signal to the first terminal within the floating time, thereby setting the potential of the second terminal to a third potential generated by the first and second potentials; and
generating the control signal based on the third potential.

2. The method of generating a control signal according to claim 1, further including outputting the control signal by supplying the potential of the second terminal to a buffer circuit as an input signal.

3. The method of generating a control signal according claim 1, further including outputting binary voltage values as the control signal in effect.

4. The method of generating a control signal according to claim 2, the voltage value of the control signal that is output by supplying the first potential to the buffer circuit as an input signal of the buffer circuit being different from the voltage value of the control signal that is output by supplying the third potential to the buffer circuit as another input signal of the buffer circuit.

5. The method of generating a control signal according to claim 1, further comprising, before the providing step, setting the potential of the second terminal to the first potential by connecting the second terminal to a first power line via a first switching element.

6. The method of generating a control signal according to claim 5, further comprising, after the providing step, setting the potential of the second terminal to the first potential by connecting the second terminal to the first power line via the first switching element.

7. The method of generating a control signal according to claim 6, further comprising, after the providing step, setting the potential of the second terminal to a fourth potential by connecting the second terminal to a second power line via a second switching element.

8. The method of generating a control signal according to claim 7, further including setting the potential of the second terminal to the first potential after setting the potential of the second terminal to a fourth potential.

9. The method of generating a control signal according to claim 1, further including using a shift register to control output timing of the sampling signal.

10. The method of generating a control signal according to claim 5, further including using a sampling signal from another sampling-signal line adjacent to the sampling-signal line to control the first switching element.

11. The method of generating a control signal according to claim 7, further including using a sampling signal from another sampling-signal line adjacent to the sampling-signal line to control the second switching element.

12. The method of generating a control signal according to claim 10, further including supplying the sampling signal, which controls the first switching element, and the other sampling signal, which controls the second switching element, via sampling-signal lines that are different from each other.

13. A control-signal generation circuit to output a control signal to control transmission of a scan signal supplied to a pixel via at least one of a scan line and a data signal supplied to another pixel via a data line based on a sampling signal supplied via a sampling-signal line, the control-signal generation circuit comprising:
a capacitive element having a first terminal connected to the sampling-signal line, a second terminal, and a capacitance provided therebetween;
a first switching element connected to the second terminal,
an output terminal connected to the second terminal that outputs a voltage signal in response to the sampling signal supplied to the first terminal via the sampling-signal line, the voltage signal being used as the control signal or being processed and used as the control signal.

14. The control-signal generation circuit according to claim 13, the first switching element, which is connected to the second terminal, controlling electrical connection between the first power line and the second terminal.

15. The control-signal generation circuit according to claim 14, further comprising a second switching element connected to the second terminal to control electrical connection between the second terminal and the second power line.

16. The control-signal generation circuit according to claim 14, the first switching element setting the potential of the second terminal to a predetermined potential by electrically connecting the first power line and the second terminal, and
in a period where the sampling signal is supplied to the first terminal, the first power line and the second terminal being electrically disconnected.

17. The control-signal generation circuit according to claim 15, the first switching element and the second switching element being controlled by sampling signals supplied via sampling-signal lines that are different from said sampling-signal line and are adjacent to said sampling-signal line.

18. The control-signal generation circuit according to claim 13, the second terminal of the capacitive element being connected to a buffer circuit.

19. The control-signal generation circuit according to claim 15, the potential of the first power line being set so as to be different from the potential of the second power line.

20. A data-line driving circuit, comprising:
signal-sampling lines;
the control-signal generation circuit according to claim 13 provided for each of the sampling-signal lines;
a shift register to control output timing of the sampling signal; and
at least one switching element controlled by an output from the control-signal generation circuit.

21. A data-line driving circuit to supply an image signal to a pixel circuit provided at a position corresponding to an intersection of a data line and a scan line via the data line, the data-line driving circuit comprising:
a shift register to control outputting of a sampling signal supplied via a sampling-signal line;
a capacitive element having a first terminal connected to the sampling-signal line, a second terminal, and a capacitance provided therebetween;
an image-signal line to transmit an image signal; and
a switching element controlled by a control signal output from an output unit connected to the second terminal in response to the sampling signal supplied to the first terminal via the sampling-signal line, the switching element being turned on when the control signal is supplied, whereby the image signal transmitted through the image-signal line is transmitted to the data line via the switching element.

22. The data-line driving circuit according to claim 21, the control signal being output only in a period where the sampling signal is supplied to the first terminal.

23. The data-line driving circuit according to claim 21,
the output unit including a buffer circuit connected to the second terminal, and
an output from the buffer circuit in the case where the potential of the second terminal in the period where the sampling signal is supplied to the first terminal being input to the buffer circuit, and
another output from the buffer circuit in the case where the potential of the second terminal in a period where the sampling signal is not supplied to the first terminal being input to the buffer circuit are different from each other.

24. The data-line driving circuit according to claim 23, the buffer circuit including an inverter circuit connected to the second terminal, and a center potential of the inverter circuit being set to a point midway between the potential of the second terminal in the period where the sampling signal is supplied to the first terminal and the potential of the second terminal in the period where the sampling signal is not supplied to the first terminal.

25. An element substrate, comprising:
a substrate;
a scan line formed on the substrate;
a pixel circuit formed on the substrate;
a scan-line driving circuit formed on the substrate to supply a scan signal to the pixel circuit via the scan line;
the data-line driving circuit according to claim 21 formed on the substrate; and
a data line formed on the substrate to supply an image signal output from the data-line driving circuit to the pixel circuit.

26. An optoelectronic device, comprising:
an optoelectronic element;
a pixel circuit to drive the optoelectronic element;
a scan line;
a scan-line driving circuit to supply a scan signal to the pixel circuit via the scan line;
the data-line driving circuit according to claim 21; and
a data line to supply an image signal output from the data-line driving circuit to the pixel circuit.

27. An electronic apparatus, comprising:
the optoelectronic device according to claim 26.

28. A control signal generation circuit to output a control signal to control transmission of a scan signal supplied to a pixel via a scan line or a data signal supplied to the pixel via a data line, the control signal generation circuit comprising:
a signal conversion unit having a first terminal and a second terminal;
a first sampling signal line connected to the first terminal, which supplies a first sampling signal; and
a second sampling signal line connected to the second terminal, which supplies a second sampling signal;
the control signal being generated based on a first potential at the first terminal and a second potential at the second terminal,
the first potential at the first terminal being controlled by the first sampling signal; and
the second potential at the second terminal being controlled by the second sampling signal.
